(19) United States
(12) Patent Application Publication
(10) Pub. No.: US 2017/0095383 A1
(43) Pub. Date: Apr. 6, 2017

(54) INTELLIGENT WHEEL CHAIR CONTROL METHOD BASED ON BRAIN COMPUTER INTERFACE AND AUTOMATIC DRIVING TECHNOLOGY

(71) Applicant: SOUTH CHINA UNIVERSITY OF TECHNOLOGY, Guangzhou (CN)

(72) Inventors: Yuanqing LI, Guangzhou (CN); Rui ZHANG, Guangzhou (CN)

(73) Assignee: SOUTH CHINA UNIVERSITY OF TECHNOLOGY, Guangzhou (CN)

(21) Appl. No.: 15/380,047

(22) Filed: Dec. 15, 2016

Related U.S. Application Data
(63) Continuation-in-part of application No. PCT/CN2014/093071, filed on Dec. 4, 2014.

(30) Foreign Application Priority Data
Jun. 17, 2014 (CN) 201410269902.5

(51) Int. Cl. A61G 5/04; G06F 3/01; G05B 6/02; G05D 1/02; G06N 99/00

(52) U.S. Cl. CPC A61G 5/04; G05D 1/0253; G05D 1/027; G05D 1/0274; G05D 1/0212; G06N 99/005; G05B 6/02; G06F 3/015; G06F 3/013; A61G 2203/22; A61G 2203/18; A61G 2203/70; G06F 3/0482

(57) ABSTRACT

Disclosed is an intelligent wheel chair control method based on a brain computer interface and an automatic driving technology. The method comprises the following steps: acquiring current pictures by webcams to perform obstacle localization; generating candidate destinations and waypoints for path planning according to the current obstacle information; performing self-localization of the wheel chair; selecting a destination by a user through the brain computer interface (BCI); planning an optimal path according to the current position of the wheel chair as a starting point and the destination selected by the user as an end point in combination with the waypoints; calculating a position error between the current position of the wheel chair and the optimal path as the feedback of a

PID path tracking algorithm; and calculating a reference angular velocity and linear velocity by means of the PID path tracking algorithm and transmitting them to a PID motion controller, converting odometry data from encoders into current angular and linear velocities as a feedback of the PID motion controller, and controlling the driving of the wheel chair in real time to the destination. The intelligent wheel chair control method greatly relieves the mental burden of a user, can adapt to changes in the environment, and improves the self-care ability of patients with severe paralysis.

### CROSS REFERENCE TO RELATED APPLICATIONS

This is a Continuation in Part of International Patent Application No. PCT/CN2014/093071, filed on Dec. 4, 2014, which claims the benefit of Chinese Patent Application No. CN 201410269902.5, filed Jun. 17, 2014. The contents of the foregoing patent applications are incorporated by reference herein in their entirety.

### FIELD

The present invention relates to the application research of brain computer interfaces and the field of artificial intelligence, in particular to an intelligent wheel chair control method based on a brain computer interface and an automatic driving technology.

### BACKGROUND

Millions of people with disabilities around the world lose the motor function due to suffering from mobility impairments. Tens of thousands of them need to rely on electric wheel chairs. But there are still a part of them losing the motor function cannot operate the traditional electric wheel chairs for two reasons: (1) they cannot control such wheel chairs through traditional interfaces (such as the control levers of the wheel chairs); and (2) they are considered unable to securely control such wheel chairs.

With the rapid development of artificial intelligence technology, more and more research achievements have been applied to assist the motor function of these people, so as to improve their quality of life. A brain computer interface (BCI) is a hot topic in the research of brain function in recent years, especially as a new kind of human-computer interaction. However, the brain computer interface as a new interactive way to control the electric wheel chair is also facing new challenges: accurate recognition of human intent by means of the brain computer interface requires a high degree of concentration. Therefore, if the driving of the wheel chair is directly controlled by the brain computer interface, it will generate a huge mental burden for the disabled. In addition, due to the instability of the brain signal, we cannot obtain the same information transfer rate as the wheel chair control lever from the prior art, and it is also difficult to achieve the control ability like the control lever.

The brain computer interface refers to a direct exchange and control channel established between the brain and a computer or other devices, which does not depend on the peripheral nervous system and muscle tissue, and is a new human-machine interface. The brain computer interfaces are divided into two types, namely invasive and non-invasive. The brain signal obtained by the invasive brain computer interface has a high quality and high signal-to-noise ratio, and is easy to be analyzed and processed; however, there is a need for the user to perform a craniotomy, which has higher risk, and is mainly used for animal experimental research. The brain signal obtained by the non-invasive brain computer interface has a large noise, and the signal features are poorly distinguishable; however, the brain signal can be obtained without any surgeries; in addition, with the continuous improvement of signal processing methods and techniques, the scalp electroencephalogram (EEG) processing has been able to reach a certain level, so that it is possible to apply the brain computer interface to real life. All the brain computer interfaces mentioned in the present invention refer to the non-invasive brain computer interfaces. Currently, the signals for use in the non-invasive brain computer interface studies include event related potentials (ERPs) such as P300, steady state visual evoked potential (SSVEP), mu and beta rhythm, slow cortical potential (SCP) and so on.

The brain computer interface usually comprises three parts: 1) signal acquisition; 2) signal processing, the user's intent is extracted from the neural signal and the input nerve signal of the user is converted into an output command for controlling the external device by means of a specific pattern recognition algorithm; and 3) control of the external device, the external device can be driven by the user's intent, so as to replace the lost ability to move and communicate.

At present, most of the brain-controlled wheel chair systems are directly controlled by the brain computer interface, and do not equip with the automatic driving technology, such as the Chinese patent publication No. CN 101897640 A entitled “A novel MI-based intelligent wheel chair control system”, and publication No. CN 101953737 A entitled “An MI-based wheel chair for disabled persons”. The scalp EEG signals of the user are collected when the user is performing left or right-hand MI, and the imaged direction of the user is judged by analyzing the EEG specific components to control the direction of the wheel chair. Chinese patent publication No. CN 102309380 A entitled “An intelligent wheel chair based on a multi-mode brain computer interface”. This invention adopts the multi-mode brain computer interface to realize the multi-degree of freedom control of the wheel chair. The start, stop, backward and speed of the electric wheel chair are controlled by the event-related potential P300; and the direction of the wheel chair is controlled by the MI. The above-mentioned invention has the following three problems: (1) wheel chair control is multi-objective, including start, stop, direction control and speed control. But the current brain computer interface is difficult to generate so many control commands Although the patent publication No. CN 102309380 A entitled “An intelligent wheel chair based on a multi-mode brain computer interface” has adopted a multi-mode brain computer interface to acquire multiple control commands, the time required to generate precise control commands via a P300- or SSVEP-based BCI is long, and thus is not suitable for an actual wheel chair control. (2) the performance of the brain-computer interface varies from person to person. For example, many people cannot generate a distinguished control signal even after long time training of MI. and (3) controlling the wheel chair by means of the brain computer interface for a long time may produce a large mental burden for the user. The above challenges can be solved by introducing the automatic driving technology into the wheel chair control system. The wheel chair with an automatic driving function does not require any control commands when navigating. But the automatic navigation system cannot perform all the control commands For example, the automatic navigation system cannot automatically identify the user's destination instructions, and therefore there is a need for a specific human-machine interface to transfer the destination information to the automatic navigation system. However, there are obstacles to the use of conventional human-machine interfaces (e.g., control levers, keyboards, etc.) for disabled persons losing the motor function, such as ALS patients. Therefore, the combination of the brain computer interface technology and the automatic driving technology will be a good choice for solving the above problems.

### SUMMARY OF THE INVENTION

An object of the present invention is to provide an intelligent wheel chair control method based on a brain computer interface and an automatic driving technology, in order to overcome the drawbacks and shortcomings of the prior art.

The object of the present invention is realized by virtue of the following technical solution:

An intelligent wheel chair control method based on a brain computer interface and an automatic driving technology comprises the sequential steps:

S1. acquiring pictures about current environment information from each webcam which is fixed on a wall face, and using an image processing method to localize obstacles according to the acquired pictures;

S2. generating candidate destinations and waypoints for path planning according to the current obstacle information;

S3. performing the self-localization of the wheel chair;

S4. selecting a destination by a user through the brain computer interface;

S5. planning an optimal path by means of a A′ algorithm according to the current position of the wheel chair as a starting point and the destination selected by the user as an end point in combination with the waypoints which are generated after the obstacle localization;

S6. calculating a position error between the current position of the wheel chair and the optimal path after acquiring the optimal path, using the position error to be a feedback of a PID path tracking algorithm, and calculating a reference angular velocity and linear velocity by means of the PID path tracking algorithm; and

S7. inputting the reference angular velocity and linear velocity to a PID motion controller, obtaining odometry data from odometers attached to the left and right wheels of the wheel chair, then converting the odometry data into current angular velocity and linear velocity as a feedback of the PID motion controller so as to adjust a control signal of the wheel chair, and controlling the driving of the wheel chair in real time to the destination.

In step S1, the positioning of the obstacle is completed by performing the sequential steps:

(1) using a threshold segmentation method to segment the obstacles from the floor in the picture;

(2) removing noises by means of a morphological opening operation, and rebuilding the regions removed in the opening operation by means of a morphological closing operation so as to obtain the contour of each segmented region;

(3) removing the relatively small contours to further remove the noises, and then fitting the remaining contours with convex hulls;

(4) mapping the vertexes of the convex hulls onto the global coordinate system, i.e. a ground plane coordinate system, according to a correspondence matrix, wherein the correspondence matrix represents the correspondence between a pixel coordinate system and the ground plane coordinate system; and

(5) calculating the intersection of the regions that correspond to the convex hulls from each picture in the global coordinate system, the position of the obstacle in the coordinate system being approximatable by these intersection regions.

In step S3, the method of self-localization of the wheel chair comprising the sequential steps:

A. Initial Localization

(1) according to distance point information obtained from a laser range finder, using a least squares fitting algorithm to extract line segments, and transforming the extracted line segments into vectors with directional information according to the scanning direction of the laser range finder; and

(2) matching the extracted vectors with the vectors in an environmental map, and calculating the current position of the wheel chair according to the matched vector pairs;

B. Process Localization

(1) according to the position information of the wheelchair in the previous time and the data of the odometers, dead reckoning the position of the wheel chair, and then transforming coordinates of the vectors obtained by the laser range finder according to the dead-reckoned position; and

(2) matching the coordinate-transformed vectors with the vectors in an environmental map, and calculating the current position of the wheel chair according to the matched vector pairs.

The step S4, specifically selecting a destination by an MI-based brain computer interface, comprises the sequential steps:

(1) representing the candidate destinations by light and dark solid circles, the two colors representing two different categories of destinations;

(2) if the user wants to select a dark/light destination, he needs to perform a left/right hand motor imagery for at least 2 seconds according to the color of a horizontal bar in the graphical user interface (GUI); when the brain computer interface system detects the left/right hand motor imagery, retaining the dark/light destinations in the GUI, and further dividing the destinations reserved in the GUI into two categories, which are distinguished respectively with the light and dark colors, the other destinations disappearing from the GUI; and

(3) repeating this selection process by the user, until only one destination is left, and finally the user needing to continue executing the left/right hand motor imagery for 2 seconds to accept/reject the selected destination.

The motor imagery detection algorithm comprises the following steps:

(1) extracting EEG signals of 1200 ms, and applying a common average reference (CAR) filter, 8-30 Hz bandpass filter;

(2) extracting a feature vector by projecting the filtered EEG signals using a common spatial pattern (CSP); and

(3) inputting the obtained feature vector to a support vector machine (SVM) classifier to obtain predicted class and the corresponding SVM output value, and if the SVM output value exceeds a certain threshold, using the corresponding class to be the output result.

The step S4, specifically selecting a destination by a P300-based brain computer interface, comprises the sequential steps:

(1) firstly, the user has 20 seconds to determine the number of the destination that he wants to select from a graphical user interface;

(2) after 20 seconds, the P300 GUI will appear on the screen, wherein the number of each flash button is the same as the number in the respective solid circle in the graphical user interface;

(3) with the P300-based brain computer interface GUI shown on the screen, the user can select the destination by gazing at the correspondingly numbered flash button; and

(4) when the destination is selected, the user needs to continue gazing at a flash button ‘O/S’ for further verification; otherwise, the user needs to gaze at the flash button ‘Delete’ to reject the last selection and re-select the destination.

The P300 detection algorithm comprises the following steps:

(1) applying a 0.1-20 Hz band-pass filter and down-sampling by a factor of 5 to EEG signals;

(2) for each flash button in the P300 GUI, extracting a segment of EEG signals from each channel to form a vector, and then combining the vectors of all channels to form a feature vector, wherein the length of the EEG signals is 600 ms after flashing;

(3) applying a SVM classifier to the feature vectors and then obtaining the values corresponding to 40 flash buttons; and

(4) after four rounds, calculating the sum of the SVM values corresponding to each button, and finding the maximum and the second maximum, if the difference between the maximum and the second maximum exceeds a certain threshold, using the button with the highest value to be the output result; otherwise, continuing to detect the preceding four rounds, until the threshold condition is satisfied, wherein one round is defined as a complete cycle, in which all the buttons flash once in a random order.

The intelligent wheel chair control method based on a brain computer interface and an automatic driving technology further comprises, during the motion of the wheel chair, if the user wants to stop the wheel chair and change the destination, he can send a stop command to the wheel chair via an MI- or P300-based BCI, which comprises the following specific steps:

(1) stopping the wheel chair by the MI-based brain computer interface: during the motion of the wheel chair, performing left-hand MI once the value of SVM classifier is above a pre-set threshold for a minimum of 3 seconds, on the one hand, the brain computer interface system sends a stop command directly to a wheel chair controller; and on the other hand, an on-board computer displays a user interface of destination selection; and

(2) stopping the wheel chair by the P300-based brain computer interface: during the motion of the wheel chair, the user simply gazes at a flash button ‘O/S’ in FIG. 3, once the brain computer interface system detects the P300 corresponding to the flash button ‘O/S’, on the one hand, the brain computer interface system sends a stop command directly to a wheel chair controller; and on the other hand, an on-board computer displays a user interface of destination selection for the user to re-select the destination.

Comparing with the prior art, the present invention has the advantages and benefits as follows:

1. the present wheel chair system introduces the concept of shared control, makes full use of advantages of human intelligence and precise control ability of automatic driving, and lets the two control different aspects to complement each other. The obstacle localization is performed by the automatic navigation system in real time based on the obstacle information which is fully sensed by the sensor (the webcams fixed on the wall face). According to the position information of the obstacles in the room, the candidate destinations for the user to choose and the waypoints for path planning are automatically generated. The user can select a destination by means of an MI- or P300-based brain computer interface. According to the selected destination, the navigation system will plan a shortest and safest path and then automatically navigate the wheel chair to the selected destination. During the motion of the wheel chair to the destination, the user can send a stop command via the brain computer interface, and the mental burden on the user can be substantially alleviated by using the system proposed in the present invention.

Each navigation task only requires the user to select the destination via the brain computer interface before the wheel chair starts, and the automatic navigation system will automatically navigate the wheel chair to reach the destination selected by the user, the user does not need to issue additional control commands during the motion of the wheelchair. Therefore, our system can greatly reduce the mental burden of the user compared with other inventions; and

2. The candidate destinations and the path along which the wheel chair drives are automatically generated according to the current environment, rather than off-line pre-defined. Therefore, our system can adapt to changes in the environment.

### BRIEF DESCRIPTION OF THE DRAWINGS

FIG. 1 is an application interface of an intelligent wheel chair control method based on a brain computer interface and an automatic driving technology of the present invention;

FIG. 2 is a diagram of a graphical user interface (GUI) for selecting a destination based on motor imagery of the method shown in FIG. 1;

FIG. 3 is a diagram of a graphical user interface (GUI) for selecting a destination based on P300 of the method shown in FIG. 1;

FIG. 4 is a systematic block diagram of the method shown in FIG. 1; and

FIG. 5 is a flow chart of a wheel chair self-localization algorithm of the method shown in FIG. 1.

### DETAILED DESCRIPTION

The present invention will be further described in detail below in connection with embodiments and the accompanying drawings, but embodiments of the present invention are not limited thereto.

### First Embodiment

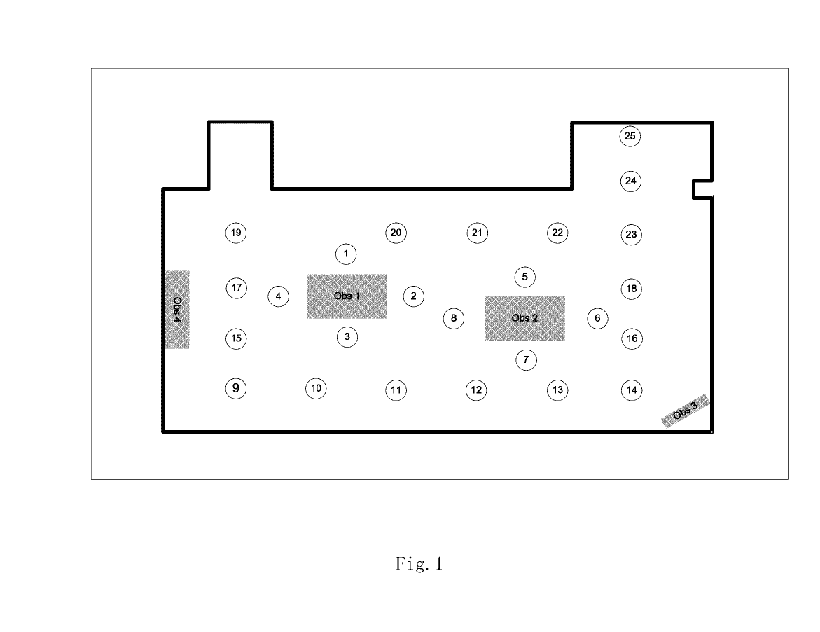

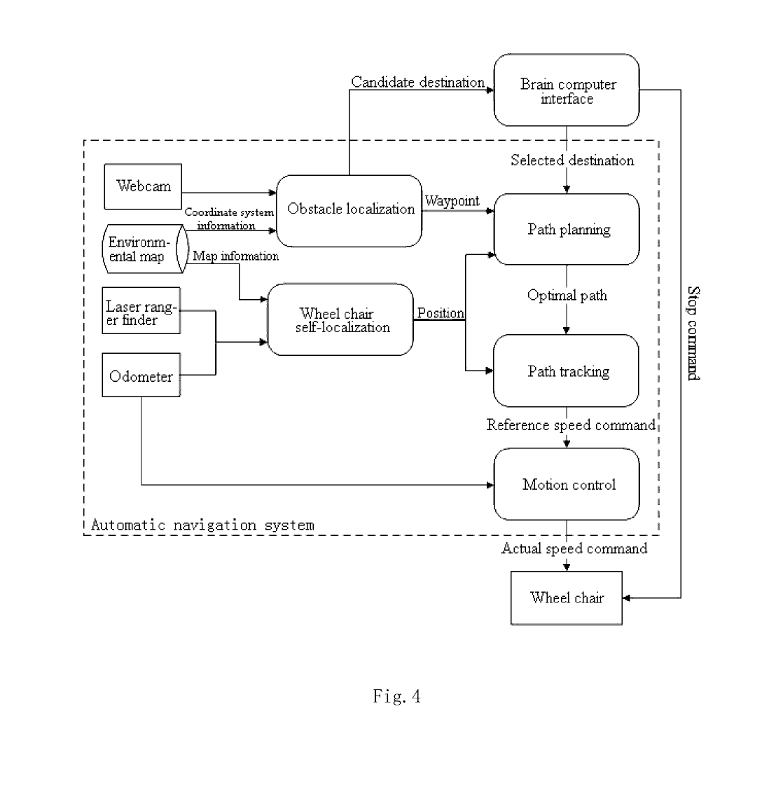

As shown in FIGS. 1, 2, 3, 4 and 5, an intelligent wheel chair control method based on a brain computer interface and an automatic driving technology comprises the sequential steps:

S1. acquiring pictures about current environment information from each webcam which is fixed on a wall face, and using an image processing method to localize obstacles according to the acquired pictures; the obstacle localization is performed by the sequential steps:

(1) using a threshold segmentation method to separate the obstacles from the floor in the picture;

(2) removing noises by means of a morphological opening operation, and rebuilding the regions removed in the opening operation by means of a morphological closing operation so as to obtain the contour of each segmented region;

(3) removing the relatively small contours to further remove the noises, and then approximating the remaining contours with convex hulls;

(4) mapping the vertexes of the convex hulls onto the global coordinate system, i.e. a ground plane coordinate system, according to a correspondence matrix, wherein the correspondence matrix represents the correspondence between the pixel coordinate system and the ground plane coordinate system; and

(5) calculating the intersection of the regions that correspond to the convex hulls from each picture in the global coordinate system, the position of the obstacle in the ground plane coordinate system being approximatable by these intersection regions;

S2. generating candidate destinations and waypoints for path planning according to information of the obstacle;

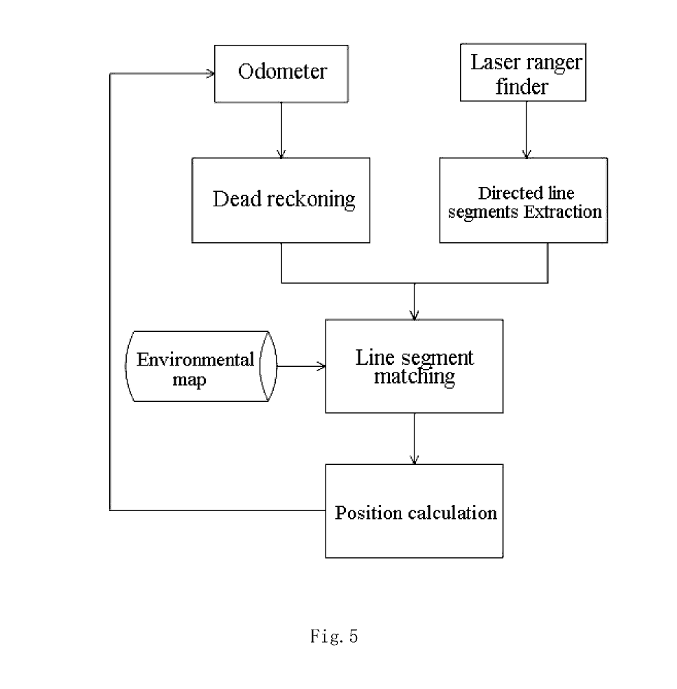

S3. as shown in FIG. 5, self-positioning the wheel chair, the method of self-positioning the wheel chair comprising the sequential steps:

The self-localization of the wheel chair is divided into two categories: initial localization and process localization.

S31. initial localization: (1) according to distance point information obtained from a laser range finder, using a least squares fitting algorithm to extract line segments, and transforming the extracted line segments into vectors according to the scanning direction of the laser range finder; and (2) matching the extracted vectors with the vectors in the environmental map, and calculating the current position of the wheel chair according to the matched vector pairs.

S32. process localization: (1) according to the position information of the wheelchair in the previous time and the odometry data of the odometers, dead reckoning the position of the wheel chair, and then transforming coordinates of the vectors obtained by the laser range finder according to the dead-reckoned position. (2) matching the coordinate-transformed vectors with the vectors in the environmental map, and calculating the current position of the wheel chair according to the matched vector pairs;

S4. selecting a destination by a user through the brain computer interface:

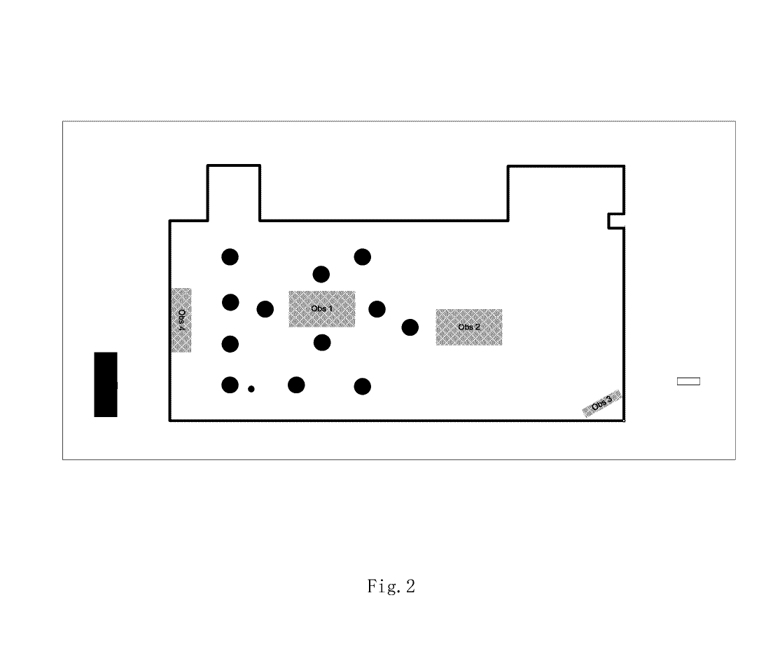

in the first instance, as shown in FIG. 2, selecting a destination by an MI-based brain computer interface, comprises the sequential steps:

(1) representing the candidate destinations by light and dark solid circles, the two colors representing two different categories of destinations;

(2) if the user wants to select a dark/light destination, he needs to perform a left/right hand motor imagery for at least 2 seconds according to the color of a horizontal bar in a graphical user interface (GUI); when the brain computer interface system detects the left/right hand motor imagery, retaining the dark/light destinations in the GUI, and further dividing the destinations reserved in the GUI into two categories, which are distinguished respectively with the light and dark colors, the other destinations disappearing from the GUI; and

(3) repeating this selection process by the user, until only one destination is left, and finally the user needing to continue executing the left/right hand motor imagery for 2 seconds to accept/reject the selected destination;

the motor imagery detection algorithm comprises the following steps:

(1) extracting EEG signals of 1200 ms, and applying a common average reference (CAR) filter, 8-30 Hz bandpass filter;

(2) extracting a feature vector by projecting the filtered EEG signals using a common spatial pattern (CSP); and

(3) inputting the obtained feature vector to a SVM classifier to obtain the predicted class and the corresponding SVM output value, and if the SVM output value exceeds a certain threshold, using the corresponding class to be the output result.

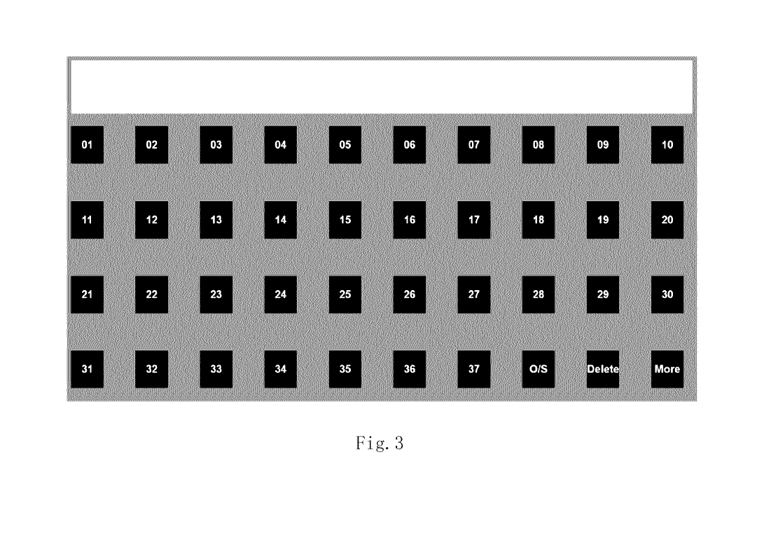

in the second instance, as shown in FIG. 3, selecting a destination by a P300-based brain computer interface, comprises the sequential steps:

(1) firstly, the user has 20 seconds to determine the number of the destination that he wants to select from the graphical user interface shown in FIG. 1;

(2) after 20 seconds, the P300 GUI (as shown in FIG. 3) will appear on the screen, wherein the number of each flash button is the same as the number of the solid circle in the graphical user interface (as shown in FIG. 1);

(3) with the P300-based brain computer interface GUI shown in FIG. 3, the user can select a destination by gazing at the correspondingly numbered flash button; and

(4) when a destination is selected, the user needs to continue gazing at a flash button ‘O/S’ for further verification; otherwise, the user needs to gaze at a flash button ‘Delete’ to reject the last selection and re-select the destination;

the P300 detection algorithm comprises the following steps:

(1) applying a 0.1-20 Hz band-pass filter and down-sampling by a factor of 5 to EEG signals;

(2) for each flash button in the P300 GUI, extracting a segment of EEG signals from each channel to form a vector, and combining the vectors of all channels to form a feature vector, wherein the length of the EEG signals is 600 ms after flashing;

(3) applying a SVM classifier to the feature vectors to obtain the values corresponding to 40 flash buttons; and

(4) after four rounds, calculating the sum of the SVM values corresponding to each button, and finding the maximum and the second maximum value, if the difference between the maximum and the second maximum value exceeds a certain threshold, using the flash button corresponding to the highest value to be the output result; otherwise, continuing to detect the preceding four rounds, until the threshold condition is satisfied. One round of button flashes is defined as a complete cycle, in which all the buttons flashes once in a random order.

S5. planning an optimal path by means of an A according to the current position of the wheel chair as a starting point and the destination selected by the user as an end point in combination with the waypoints which are generated after the obstacle localization;

S6. calculating the position error between the current position of the wheel chair and the optimal path after acquiring the optimal path, using the position error as the feedback of the PID path tracking algorithm, and then calculating a reference angular velocity and linear velocity by means of the PID path tracking algorithm; and

S7. inputting the reference angular velocity and linear velocity to a PID motion controller, obtaining odometry data from odometers attached to the left and right wheels of the wheel chair, then converting the odometry data into current angular velocity and linear velocity information as the feedback of the PID motion controller so as to adjust the control signal of the wheel chair, and controlling the driving of the wheel chair in real time to the destination;

S8. if the user wants to stop the wheel chair and change the destination, sending a stop command to the wheel chair by means of a P300- or MI-based brain computer interface, which comprises the following specific steps:

(1) stopping the wheel chair by the MI-based brain computer interface: during the motion of the wheel chair, performing a left-hand MI once the value of SVM classifier is above a pre-set threshold for a minimum of 3 seconds, on the one hand, the brain computer interface system sends a stop command directly to a wheel chair controller; and on the other hand, an on-board computer displays a user interface of destination selection; and

(2) stopping the wheel chair by the P300-based brain computer interface: during the motion of the wheel chair, the user simply gazes at the flash button ‘O/S’ in FIG. 3, once the brain computer interface system detects the P300 corresponding to the flash button ‘O/S’, on the one hand, the brain computer interface system sends a stop command directly to a wheel chair controller; and on the other hand, an on-board computer displays a user interface of destination selection for the user to re-select the destination.

### Second Embodiment

The invention will now be described by way of more specific embodiments:

EEG signals are collected via an electrode cap worn by the user;

the collected EEG data is transmitted to an on-board computer to be processed in real time; meanwhile, a SICK LMS 111 laser range finder fixed in the front of the wheel chair transmits data to the on-board computer through a TCP network in real time for self-localization of the wheel chair; odometers attached to the left and right wheels of the wheel chair transmit real-time data through serial ports, which is converted into a linear velocity and angular velocity as the feedback data of a PID controller to adjust the current velocity of the wheel chair in real time;

the webcams fixed on the wall face of the room are connected to the on-board computer through a wireless network, the on-board computer controls the webcams whether to transmit the current image data and perform image processing, and the obstacles in the room are segmented from the floor by the image processing technology so as to localize the obstacles in the room;

after the obstacle localization is finished, the automatic navigation system automatically generates user-selectable candidate destinations, which are distributed around the obstacles and evenly distributed on an open space at a distance of 1 meter; a generalized Voronoi diagram is constructed according to the distribution of the obstacles in the room, the edges of the constructed Voronoi diagram are used to be the path along which the wheel chair can pass, the paths formed in this way are as far as possible away from the obstacles on both sides thereof, and therefore using these paths to be the navigation paths is the most secure; and waypoints are extracted every 0.2 m along the edges of the Voronoi diagram, and the coordinate information of each waypoint and adjacent relations between waypoints are input into a path planning module. Once the user selects a destination, the path planning module plans a shortest path according to the current position of the wheel chair, the position of the destination, and the information of the waypoints;

and a path tracking module calculates a reference linear velocity and angular velocity according to the current position of the wheel chair and the planned path. Taking into account the safety and comfort of the wheel chair, the linear velocity is fixed to 0.2 m/s and the angular velocity is not more than 0.6 rad/s; and the reference linear velocity and angular velocity are transmitted to a motion control module (i.e., PID controller), and the controller controls the driving of the wheel chair to the destination in real time according to the collected odometer information as the feedback of the current speed.

The aforementioned embodiments of the present invention are preferred embodiments of the present invention, but embodiments of the present invention are not limited to the aforementioned embodiments, and any other change, modification, substitution, combination, and simplification made without departing from the spirit and principles of the present invention should be an equivalent replacement, and is included within the scope of protection of the present invention.

We claim:

1. An intelligent wheel chair control method based on a brain computer interface and an automatic driving technology, characterized by comprising the sequential steps:
S1. acquiring pictures about current environment information from each webcam which is fixed on a wall face, and then using an image processing method to localize obstacles according to the acquired pictures;
S2. generating candidate destinations and waypoints for path planning according to the current obstacle information;
S3. performing the self-localization of the wheel chair;
S4. selecting a destination by a user through the brain computer interface;
S5. planning an optimal path by means of an A′ algorithm according to the current position of the wheel chair as a starting point and the destination selected by the user as an end point in combination with the waypoints which are generated after the obstacle localization;
S6. calculating a position error between the current position of the wheel chair and the optimal path after acquiring the optimal path, using the position error to be a feedback of a PID path tracking algorithm, and then calculating a reference angular velocity and linear velocity by means of the PID path tracking algorithm; and
S7. inputting the reference angular velocity and linear velocity to a PID motion controller, obtaining odometry data from odometers attached to the left and right wheels of the wheel chair, then converting the odometry data into current angular velocity and linear velocity as a feedback of the PID motion controller so as to adjust a control signal of the wheel chair, and controlling the driving of the wheel chair in real time to the destination.

2. The intelligent wheel chair control method based on a brain computer interface and an automatic driving technology according to claim 1, characterized in that step S1, the obstacle localization is completed by performing the sequential steps:
(1) using a threshold segmentation method to separate the obstacles from the floor in the picture;
(2) removing noises by means of a morphological opening operation, and rebuilding the regions removed in the opening operation by means of a morphological closing operation so as to obtain the contour of each segmented region;
(3) removing the relatively small contours to further remove the noises, and then approximating the remaining contours with convex hulls;
(4) mapping the vertexes of the convex hulls onto the global coordinate system, i.e. a ground plane coordinate system, according to a correspondence matrix, wherein the correspondence matrix represents the correspondence between a pixel coordinate system and the ground plane coordinate system; and
(5) calculating the intersection of the regions that correspond to the convex hulls from each picture in the global coordinate system, the position of the obstacle in the ground plane coordinate system being approximatable by these intersection regions.

3. The intelligent wheel chair control method based on a brain computer interface and an automatic driving technology according to claim 1, characterized in that in step S3, the method of self-localization of the wheel chair comprising the sequential steps:
A. initial localization
(1) according to distance point information obtained from a laser range finder, using a least squares fitting algorithm to extract line segments, and transforming the extracted line segments into vectors with directional information according to the scanning direction of the laser range finder; and
(2) matching the extracted vectors with the vectors in an environmental map, and calculating the current position of the wheel chair according to the matched vector pairs;
B. process localization
(1) according to the position information of the wheelchair in the previous time and the data of the odometers, dead reckoning the position of the wheel chair, and then transforming coordinates of the vectors obtained by the laser range finder to the global coordinates according to the dead-reckoned position; and
(2) matching the coordinate-transformed vectors with the vectors in an environmental map, and calculating the current position of the wheel chair according to the matched vector pairs.

4. The intelligent wheel chair control method based on a brain computer interface and an automatic driving technology according to claim 1, characterized in that step S4, specifically selecting a destination using a motor imagery (MI)-based brain computer interface, comprises the sequential steps:
(1) representing the candidate destinations by light and dark solid circles, respectively, the two colors representing two different categories of destinations;
(2) if the user wants to select a dark/light destination, he needs to perform a left/right hand motor imagery for at least 2 seconds according to the color of a horizontal bar in a graphical user interface (GUI); when the brain computer interface system detects the left/right hand motor imagery, retaining the dark/light destinations in the GUI, and further dividing the destinations reserved in the GUI into two categories, which are distinguished respectively with the light and dark colors, the other destinations disappearing from the GUI; and
(3) repeating this selection process by the user, until only one destination is left, and finally the user needing to continue executing the left/right hand motor imagery for 2 seconds to accept/reject the selected destination.

5. The intelligent wheel chair control method based on a brain computer interface and an automatic driving technology according to claim 4, characterized in the motor imagery detection algorithm comprises the following steps:
(1) extracting EEG signals of 1200 ms, and applying a common average reference filter, 8-30 Hz bandpass filter;
(2) extracting a feature vector by projecting the filtered EEG signals using a common spatial pattern; and
(3) inputting the obtained feature vector to a support vector machine (SVM) classifier to obtain the predicted class and the corresponding SVM output value, and if the SVM output value exceeds a certain threshold, using the corresponding class to be the output result.

6. The intelligent wheel chair control method based on a brain computer interface and an automatic driving technology according to claim 1, characterized in that step S4, specifically selecting a destination by a P300-based brain computer interface, comprises the sequential steps:
(1) firstly, the user has 20 seconds to determine the number that corresponds to his desired destination from the graphical user interface;
(2) after 20 seconds, the P300 GUI will appear on the screen, wherein the number of each flash button is the same as the number in the respective solid circle in the graphical user interface;
(3) with the P300-based brain computer interface GUI shown on the screen, the user can select the destination by gazing at the correspondingly numbered flash button; and
(4) when the destination is selected, the user needs to continue gazing at the flash button ‘O/S’ for further verification; otherwise, the user needs to gaze at the flash button ‘Delete’ to reject the last selection and reselect the destination.

7. The intelligent wheel chair control method based on a brain computer interface and an automatic driving technology according to claim 6, characterized in the P300 detection algorithm comprises the following steps:
(1) applying a 0.1-20 Hz band-pass filter and down-sampling by a factor of 5 to EEG signals;
(2) for each flash button in the P300 GUI, extracting a segment of EEG signals from each channel to form a vector, and then combining the vectors of all channels to form a feature vector, wherein the length of the EEG signals is 600 ms after flashing;
(3) applying a SVM classifier to the feature vectors and then obtaining the values corresponding to 40 flash buttons; and
(4) after four rounds, calculating the sum of the SVM values corresponding to each button, and finding the maximum and the second maximum, if the difference between the maximum and the second maximum exceeds a certain threshold, using the button with the highest value to be the output result; otherwise, continuing to detect the preceding four rounds, until the threshold condition is satisfied, wherein one round of button flashes is defined as a complete cycle, in which all the buttons flash once in a random order.

8. The intelligent wheel chair control method based on a brain computer interface and an automatic driving technology according to claim 1, characterized by further comprising, during the motion of the wheel chair, if the user wants to stop the wheel chair and change the destination, he can send a stop command to the wheel chair via an MI- or P300-based BCI, which comprises the following specific steps:
(1) stopping the wheel chair by the MI-based brain computer interface: during the motion of the wheel chair, performing left-hand MI once the value of SVM classifier is above a pre-set threshold for a minimum of 3 seconds, on the one hand, the brain computer interface system sends a stop command directly to a wheel chair controller; and on the other hand, an on-board computer displays a user interface of destination selection; and
(2) stopping the wheel chair by the P300-based brain computer interface: during the motion of the wheel chair, the user simply gazes at a flash button ‘O/S’ in FIG. 3, once the brain computer interface system detects the P300 corresponding to the flash button ‘O/S’, on the one hand, the brain computer interface system sends a stop command directly to a wheel chair controller; and on the other hand, an on-board computer displays a user interface of destination selection for the user to re-select the destination.
